(19) United States
(12) Patent Application Publication
(10) Pub. No.: US 2010/0033566 A1
(43) Pub. Date: Feb. 11, 2010

(54) DIGITAL LOGGING VCR META DATA BASED SYSTEM CONSTRUCT

(75) Inventors: Marine Drive, Karnataka (IN); NarayanaMurthy J. Subramanya, Karnataka (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/186,258

(22) Filed: Aug. 5, 2008

(51) Int. Cl. H04N 7/18

(52) U.S. Cl. 348/143; 348/E07.085

(57) ABSTRACT

A system and method of digitally logging surveillance operator actions create a computer-implemented data structure object, monitor and receive one or more operator actions of a security monitoring operator, record in real time said one or more operator actions in said data structure object, and store said data structure object in memory.

### FIELD OF THE INVENTION

The present disclosure relates to security systems and more particularly to digital logging VCR meta data based system construct.

### BACKGROUND OF THE INVENTION

Surveillance systems and cameras are typically operated by a plurality of operators each having a monitor or like to view or survey an area being secured or monitored. While each operator may separately handle securing or monitoring of a designated area, there are times when a plurality of operators may desire to synchronize and view, capture or monitor the same set of scenes or perform the same set of operations.

U.S. Pat. No. 6,856,343 to Arazi et al. discloses a digital video logging system that has a logging apparatus able to synchronize at least two digitally formatted video input and digital storage apparatus to store the digitally formatted input.

U.S. Pat. No. 6,877,134 to Fuller et al. discloses a system and method for a digital capture system, such as a digital encoder, having an embedded real-time content-based analysis function in the capture device to extract metadata from the digital signals. Metadata (descriptive information about the digital content) is formatted and stored separately from the content. The metadata also may be formatted and combined with the digital content in a container format such as MPEG-7, QuickTime, or FlashPix. Digital encoding mechanisms, both pure hardware and hardware/software combinations, convert an analog video signal into a digitally encoded video bitstream. The system extracts metadata in real-time during the encoding process.

United States Patent Application Pub. No. 20040005141 A1 to Robert G. Combs discloses a system for collecting, storing, and reviewing data related to events occurring under the direction of an automated controller. The system includes a digital signal capture card for sensing and collecting discrete digital signals, a multi-port serial port expansion card for sensing and collecting serial digital communication messages, a video frame grabber and compression card for sensing and collecting video signals, a device for indexing and storing the digital and video signals, and for relating occurrence of a particular item of a particular data type, whether digital, serial or video, to the most closely time-related data item from the other data types, and a display for control of the system and presentation of recorded data to a user during review.

International application published under the Patent Cooperation Treaty (PCT), WO9411995 to Harvey Dubner and Robert Dubner discloses an improved videotape logging device comprising a recording member for recording audio information and video information. The audio information and video information are linked together, so that the videotape can be logged by either audio cut points or video cut points. The device also includes a videotape scene change detector, coupled to a memory device for storing a plurality of selective frames, preferably one from each scene. Also included in the system is circuitry for displaying a plurality of frames simultaneously on a video display monitor or computer, which frames have been reduced from the complete frames by selective sampling. The generation of a video signal representative of the audio information is provided. The video signal clearly delineates the ends and beginnings of words to facilitate finding cut points on a videotape. Annotation of stored frames is also provided.

### BRIEF SUMMARY OF THE INVENTION

A system and method of digitally logging surveillance operator actions are provided. In one aspect, the method may comprise creating a computer-implemented data structure object; receiving one or more operator actions of a security monitoring operator; recording in real time said one or more operator actions in said data structure object; and storing said data structure object in memory.

A system digitally logging surveillance operator actions, in one aspect, may comprise a processor; a data structure object created to record one or more operator actions of a security monitoring operator; said processor operable to monitor one or more operator actions of a selected security monitoring operator and record said one or more operator actions; said processor further operable to transmit said one or more operator actions to a second operator's processor, wherein said second operator's processor receives and replays said one or more operator actions on said second operator's console.

A program storage device readable by a machine, tangibly embodying a program of instructions executable by the machine to perform the above-described method steps may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method of recording operator actions into a system object in one embodiment.

FIG. 2 illustrates a method of playing back stored or recorded object in one embodiment of the present disclosure.

FIG. 3 is a system diagram illustrating digital logging VCR meta data based system in one embodiment of the present disclosure.

### DETAILED DESCRIPTION OF THE INVETION

Digital system with digital monitors and the ability to record all of the operator actions in a logging mode and construct an internal “logging” object is provided. An object refers to a computer-implemented data structure that for example can store various data in an organized manner. The creation of a logging object may be set by default in the system, may be monitor based, may be initiated by an occurrence of a system alarm and/or event, or may be even set manually. Once initiated, the object stores all the operations, review actions, database interactions, and control and command sequences into one construct with proper timing information. The entire information may be cached into this object. The system is also enabled to reply the constructed object onto the digital monitor, when or if a logging review is needed or desired.

The system and method of the present disclosure in one embodiment record or mimic all operator actions with timing information within the context of a security/surveillance application. This may include any action that the operator is allowed to perform from his workstation or onto the other surveillance/security monitors. The system and method include the ability to watch and mimic the operator actions, for example, from an administrative console, for example, for efficiency tracking purposes, share the actions among operators in case of an incident management, record the actions into a persist-able object for forensics purposes.

In one aspect, a recording phase in the system and method of the present disclosure may comprise recording all the operator actions into a system object. Another phase, a playback phase plays back the recorded operations onto the same or different console.

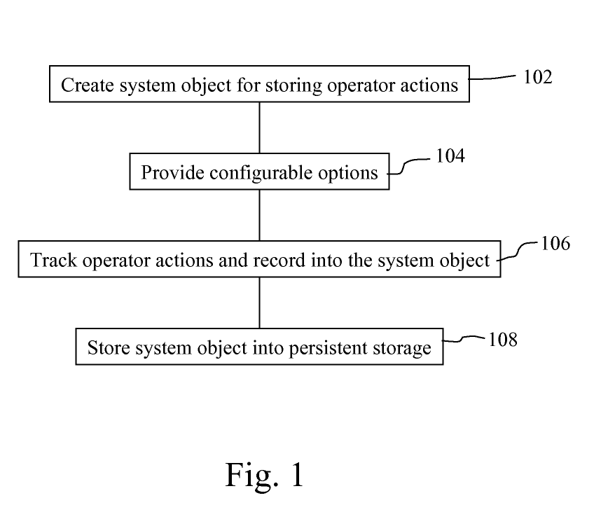

FIG. 1 is a flow diagram illustrating a method of recording operator actions into a system object in one embodiment. The recording phase in one embodiment may comprise the following steps or actions. The system records all the operator actions with the associated timing information. In one embodiment, one system object may be created per day per operator as shown at 102. The system may provide configurable options to configure various parameters related or associated with the object at 104. Duration may be entered to specify this tracking object to be persisted. For example, a persistence range may be specified, for instance, starting from one hour all the way up to a year. The system configuration could be inputted to the system by means of a text file, XML file, or by a related service to the application, or like, or user input via a user interface screen, etc. At 106, operator actions are received and stored into an object. The timing information is also stored with respect to the operator actions, that is, the time those actions occurred. At 108, the recorded actions or object are saved, for example, on a permanent storage such a hard disk, tape, etc.

The operator actions that may be recorded may include the actions performed by the operator onto a console or the monitor wall shared between operators or on the secondary monitor that the operator has access to at run time. Examples of those actions may include, but are not limited to, switching of cameras, monitors, PTZ, calling pre-shots, digital modifications to the picture including brightness, contrast, blur, sharpness, color corrections, de-interlacing, drawing standard and non-standard shapes as annotations overlay on the picture, camera messages, alarms interaction including acknowledgment (ack), clear, adding notes, sending broadcast messages to operators, sending one-to-one messages between operators. Recorded action may also include any other operator actions performed by the operator in his or her designated or shared workstation or monitor. A person of ordinary skill in the art would appreciate that operator actions and inputs can be read or received from input devices and recorded. For instance, an application interface that reads user input on the keyboard or input device, for instance, can interpret the data entered, mouse clicks or movements, buttons pressed, knobs turned, etc. Such data may be saved or stored in the native form or translated into text description of the user actions.

The stored record object may be accessible from within an application that also implements the recording. In another embodiment, separate applications maybe implemented for recording and playback. A recorded object can be used in several modes. The following illustrate examples of the different modes in which a recorded object may be utilized.

### Incident Lock Mode

Incident Lock Mode is a live mode meaning one operator's actions are all stored and played back onto a secondary monitor or by another operator in real time. In real time mode, time is synchronized and the delay of replaying is minimal, for instance, less than one second. In one aspect, one second may be an acceptable delay in these applications for replaying scenarios. For example, an operator's actions (for example, first operator's actions) are replayed instantaneously in another operator's monitor (for example, second operator's monitor). In one aspect, an operator's actions are first transmitted to another or second operator in real time and may be also stored in the background. In one aspect, the storing need not be in real time, rather, the application may perform the storing when the application gets an opportunity, for instance, the first opportunity to perform the storing after other actions having higher priority have been handled.

Incident Lock Mode may be useful in sharing data among operators when an incident happens. For instance, an operator may request “to lock” with another operator. Once locked all the actions performed on one monitor is replayed or played back at real time on the monitor of the other operator (e.g., second operator). The request to lock may be requested from an operator having lower priority to another operator that has higher priority. The requested operator acknowledges (acks) the request and the lock mode is initiated. This request to lock and acknowledgment may also occur between the operators in the same priority.

Consider the following example. An incident occurs in a room or area being under surveillance. One of the operators notices a suspicious person or activities and would like to share this incident with the second operator, so that both operators can track the person or activities. The system and method of the present disclosure allows those operators to track the incident, for example, in real time.

In one embodiment, there may be a list of priority numbers, for example, 1-99, with one being the lowest and 99 being the highest. Each operator may be assigned a priority number. An acknowledgement process may utilize the priority numbers to determine and decide which requests for sharing incidents should be acknowledged or declined. As an example, a co-worker (first co-worker) may want to share some information with another co-worker (second co-worker). If the second co-worker is busy attending to another matter, the second co-worker depending on his or her priority number may accept or decline the request to lock onto the first operator's monitor. In one embodiment, an operator with higher priority may have an option to decline the request to share from an operator with lower priority. If the operators are at the same level or have the same priority, request and accept process may be skipped.

### Admin Lock Mode

Admin lock mode is also a live mode where the replay occurs at real time. This admin lock mode differs from the above-described incident lock mode in that an administrator without the knowledge of the operator can lock and view and/or replay all the operator actions. This mode may provide an effective way to track operator efficiency. Administrator login may have the ability to list all logged in operators in the system, for example, in a standard report list. The administrator may select one of the listed operators from the list, for example, by double clicking or selecting the operator through a check selection on a menu item on a user interface screen. Once selected, the system and method of the present disclosure may prompt the administrator and ask whether the administrator would like to lock. A yes/no dialog selection box or like on the user interface screen may allow the administrator to answer yes or no. If the administrator selects “yes,” the system and method of the present disclosure in one embodiment tracks that particular operator actions and replays the same in the administrator console. As an example, in the above-described scenario, an operator may be erroneously concentrating on a camera not located where the suspicious person may be or zooming in on a wrong camera. An administrator may detect the error and further correct or provide guidance.

### Forensics Replay Mode

Forensics replay mode provides a standard playback mode that can be replayed at anytime after the incident occurs, for example, for investigation purposes.

### Tour Mode

An operator may decide a routine set of operations, store them and use them as standard tour mode for his or her daily operations. The system and method of the present disclosure may allow storing the set of operations as an individual preference onto his workstation. This mode may be supported as a shared mode for the administrators or another operator to create customized tours and push the set of operations to various operators to perform their daily routine more effectively. The other operators in the system can use this set of operations to perform a daily scheduled task list. As an example, a task list may include:
1. Drag and drop lobby camera
2. Camera plays live for 30 seconds
3. Switch to the next camera in the stair way
4. PTZ control the camera (pan tilt zoom the camera) to look at certain designated positions
5. Repeat this for other camera.

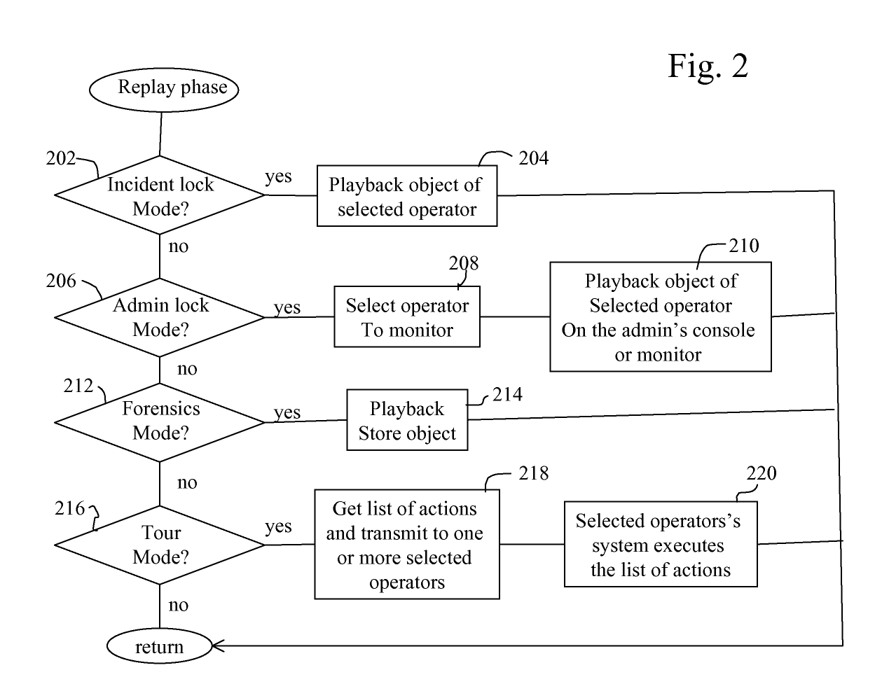

FIG. 2 illustrates a method of playing back stored or recorded object in one embodiment of the present disclosure. At 202, if the playback mode is in incident lock mode, the actions of an operator recorded in an object is replayed in real time, e.g., instantaneously as those actions occur, on one or more selected second operator monitors or consoles at 204. As described above, this incident lock mode may be set up, for instance, with request and acknowledgment initialization processed between or among the operators. If at 206, the replay mode is in admin lock mode, an administrator selects an operator to monitor at 208. At 210, the actions of the selected operator recorded in an object are replayed on the administrator's monitor in real time.

If at 212, the replay mode in is forensics replay mode, the stored object recording the actions of an operator is replayed at 214. In this mode, the actions recorded in an object may be replayed and paused at any instant of the replay, for instance, for closer scrutinization as desired. If at 216, the replay phase in tour mode, a list or set of operator actions, for example, pre-stored or entered via a user interface, may be pushed or transmitted to one or more selected operator consoles at 218. At 220, the operator consoles receive the list of actions and perform those actions automatically, for example, as daily routine or like. A person of ordinary skill in the art will appreciate that the actions recorded in an object may be played back, for example, by utilizing a computer application or software or like that can read the object and interpret the actions, and automatically control the relevant devices to perform those actions.

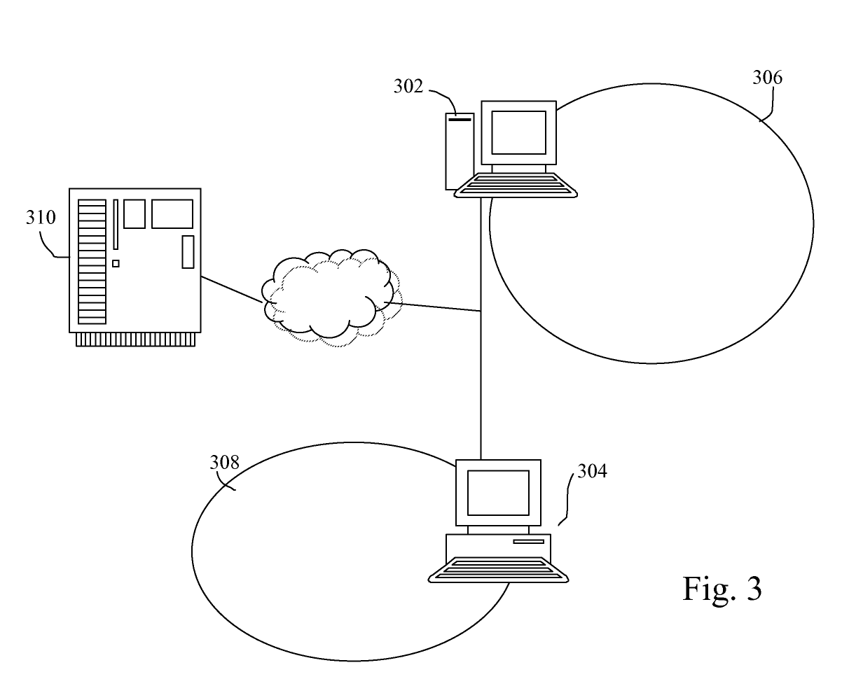

FIG. 3 is a system diagram illustrating digital logging VCR meta data based system in one embodiment of the present disclosure. Meta data herein refers to internal data related to operations performed by the security or surveillance operators. An operator 302 may be responsible for handling security or surveillance of an area 306. Another or second operator 304 may be responsible for handling security or surveillance of another or second area 308. Each operator 302, 304 has a computer system or processor, a console or monitor and various surveillance devices such as cameras for handling security or surveillance tasks. The operator devices may be connected via a network such as local area network (LAN), wide area network (WAN), wireless network, and/or Internet. The areas 306 and 308 being surveyed may overlap or may be different areas. The actions of the operator 302, for example, meta data, and output results of those actions may be recorded as an object, e.g., a computer-implemented data structure or construct that for example can store various data such as sequence of actions in an organized manner at the console associated with the operator 302 or even via a network by a central controller 310. The recordings stored as objects may be replayed in various forms. The object may be replayed on another or second operator 304 as desired or configured. For instance, the object recording all actions of the first operator 302 may be played back in real time on the console or monitor of the second operator 304. In another aspect, the object recording all actions of the first operator 302 may be played back, in non-real time, for example to examine the actions more closely by playing, slow action playing, and/or pausing the play, or like, the actions, and examining the results of the actions.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. For instance, the messaging protocol need not be limited to SMS, but may be in another protocol that transports without encrypting capabilities. Thus, various changes and modifications may be effected by one skilled in the art without departing from the spirit or scope of the invention as defined in the appended claims.

What is claimed is:

1. A method of digitally logging surveillance operator actions, comprising:
creating a computer-implemented data structure object;
receiving one or more operator actions of a security monitoring operator;
recording in real time said one or more operator actions in said data structure object; and
storing said data structure object in memory.

2. The method of claim 1, further including providing configurable options for creating the computer-implemented data structure object.

3. The method of claim 2, wherein the configurable options include duration of persistence for the data structure object.

4. The method of claim 1, wherein the step of storing includes storing said data structure object in persistent memory.

5. The method of claim 1, wherein said step of recording includes recording in real time said one or more operator actions with timing information in said data structure object.

6. The method of claim 1, wherein the computer-implemented data structure object records one operator's actions for one day.

7. The method of claim 1, further including:
replaying said computer-implemented data structure object on a second operator's console.

8. The method of claim 7, wherein said step of replaying includes replaying in real time said one or more actions from said computer-implemented data structure object.

9. The method of claim 7, farther including selecting said second operator before replaying on said second operator's console.

10. The method of claim 9, wherein said selecting includes sending a request to said second operator and receiving an acknowledgment from said second operator.

11. The method of claim 10, wherein said second operator has an option to accept or decline the request based on said second operator's priority compare to priority of said security monitoring operator.

12. The method of claim 7, wherein said second operator selects one or more objects of respective one or more security monitoring operators and said second operator replays said one or more selected objects in real time on said second operator's consoles.

13. The method of claim 12, wherein said second operator is an administrator overseeing one or more security monitoring operators.

14. The method of claim 1, further including pushing said one or more operator actions to one or more selected operators, wherein said one or more operator actions are automatically performed by monitoring systems of said one or more selected operators.

15. A system digitally logging surveillance operator actions, comprising:
a processor;
a data structure object created to record one or more operator actions of a security monitoring operator;
said processor operable to monitor one or more operator actions of a selected security monitoring operator and record said one or more operator actions;
said processor further operable to transmit said one or more operator actions to a second operator's processor, wherein said second operator's processor receives and replays said one or more operator actions on said second operator's console.

16. The system of claim 15, wherein said data structure object is created per operator.

17. The system of claim 15, further including a user interface operable to allow a user to configure one or more configurable parameters associated with the data structure object.

18. The system of claim 15, further including a storage device for persistently storing said data structure object.

19. A program storage device readable by a machine, tangibly embodying a program of instructions executable by the machine to perform a method of digitally logging surveillance operator actions, comprising:
creating a computer-implemented data structure object;
receiving one or more operator actions of a security monitoring operator;
recording in real time said one or more operator actions in said data structure object; and
storing said data structure object in memory.

20. The program storage device of claim 19, further including providing configurable options for creating the computer-implemented data structure object.
